(19) United States
(12) Patent Application Publication
(10) Pub. No.: US 2024/0288379 A1
(43) Pub. Date: Aug. 29, 2024

(54) AUTOMOTIVE GLAZING WITH SAFETY STATUS DETECTION

(71) Applicant: AGP America S.A., Ciudad de Panama (PA)

(72) Inventor: Alexey KRASNOV, Canton, MI (US)

(21) Appl. No.: 18/571,971

(22) PCT Filed: Jun. 18, 2022
(86) PCT No.: PCT/IB2022/055677

§ 371 Date: Dec. 19, 2023

Related U.S. Application Data
(60) Provisional application No. 63/212,643, filed on Jun. 19, 2021.

(51) Int. Cl. G01N 21/94; B60S 1/08; G01N 21/88

(52) U.S. Cl. CPC G01N 21/94; G01N 21/8806; B60S 1/0837; G01N 2201/0612; G01N 2201/062

(57) ABSTRACT

An automotive glazing system, comprising: at least one glass layer (2); a plurality of light emitters (10) injecting light into at least a portion of at least one edge of the glazing; a plurality of light detectors (20) measuring simultaneously the intensity of light emitted by each of said plurality of light emitters from at least a portion of at least one edge of the glazing; and at least one processing unit (15) communicably coupled to the automotive glazing, the plurality of light emitters and the plurality of light detectors to: scan periodically the intensity of light received by said plurality of light detectors; store the scanned data; compare new scans with historical data; estimate the presence of contaminants by a drop in intensity at some detectors without an increase at some detectors; and estimate the safety status of the glazing by identifying permanent damage by an increase in intensity at some detectors.

### TECHNICAL FIELD

The invention relates to the field of automotive glazing.

### BACKGROUND ART

One of the leading trends in the automotive industry that has emerged and has been accelerating over the last twenty plus years, has been the development of more and more autonomous vehicle functions. Functions that were once exclusively relegated to the operator of the vehicle are slowly being automated.

While many of these automated functions are motivated by the desire to differentiate a model by improving comfort and providing added convenience, many also enhance the safety of the vehicle.

An early example of such automation is the rain sensor which can be used to operate the windshield wipers automatically based upon the presence and quantity of water detected on the windshield. A rain sensor allows the wipers to be automatically operated before the driver may even notice or have time to react to sudden change in the weather or to a blinding splash.

Another example is adaptive cruise control which detects the speed of the vehicle ahead and adjusts the speed to maintain a safe following distance, unlike traditional cruise control which just maintains a set speed.

Some lead vehicle detection systems are integrated with the braking system and can apply the brakes avoiding collisions caused by a vehicle suddenly slowing down or stopping, rapidly bringing the vehicle to a complete stop.

The windshield plays an important part in the safety of the occupants of the vehicle during the operation of the vehicle. Safety system cameras need a high, forward looking, field of view making the windshield the ideal location to mount the cameras. The windshield is an essential optical component of camera-based safety systems. In the event of a collision the windshield serves to prevent and minimize injury to the occupants. Damage to the glass surface or the accumulation of debris may compromise the safe operation of the vehicle. However, very little has been done to automate detection of potential conditions that can degrade the safety status of the windshield.

Windshields are a type of laminated safety glass. Safety glass is glass that conforms to all applicable industry and government regulatory safety requirements for the application. Laminated safety glass is made by bonding two layers of annealed glass together using a plastic bonding layer 6 comprised of a thin sheet of transparent thermoplastic. Annealed glass breaks into large shards with sharp edges. When laminated annealed glass breaks, the shards of broken glass are held together by the plastic bonding layer 6, much like the pieces of a jigsaw puzzle, helping to maintain the structural integrity of the glass. The plastic bonding layer 6 helps to prevent penetration by objects striking the laminate from the exterior and in the event of a crash occupant retention is improved.

A vehicle with a broken windshield can still be operated and may not require immediate replacement of the windshield. However, there are some situations where a broken windshield needs to be detected immediately. In some instances, a human detection is just not fast enough. Such is the case when a heated windshield breaks under power. If the conductive coating of a heated windshield should develop even a small break, the disruption in the current flow can create a hot spot which can potentially result in injury or fire. The crack can also create an electrical human contact hazard by leaving the conductor exposed.

A number of disclosures teach how to detect such a break by monitoring the current flow and inferring that there is a break when there is a sudden change in current. Another method looks for abrupt electrical noise characteristic of the arcing that occurs when a heated windshield breaks.

However, these methods will not detect cracks that do not break the continuity of the coating at least on a scale large enough to result in arcing or a detectable change in current. Of course, they are of no use on a glazing that does not have a conductive coating.

A system that utilizes an array of sensors mounted to an aircraft glazing is known in the art. Various sensors including impact, moisture, arc, and temperature detection are mounted to the glazing. The signals are input into a processing unit which estimates the condition of the glazing. Breakage is not directly detected. The arc sensor will detect a break in the heated coating and the impact sensor will recognize an impact that could possibly damage the glazing.

Larger cracks from impacts will likely be noticeable but are often ignored by the operator. It is important to recognize small defects early on. Progress has been made in developing a process to repair defect resulting from damage to laminated annealed glass. The damaged area is cleaned, filled with a resin, the resin is cured and then the repaired area is buffed out resulting in a near undetectable repair. The repair is far less expensive than replacement and requires less time. But there are limits on just how large and bad of a break can be repaired.

Once the glass has cracked, the crack is a weak spot. As the glass surface flexes, the opposite edges will push against each other forcing the crack to open further. In the same manner, if the glass is placed in tension, the crack acts as a stress concentrator.

In order to prevent this, it is important to perform the repair as soon as possible while it can still be fixed. A human may not notice the crack or may assume that it is not big enough to have it fixed or that it has grown. In fact, there actually is a threshold for the severity required to perform an effective repair.

More subtle is the type of surface damage that occurs over time. Some types of damage may be so gradual as to go unnoticed until they have degraded to an advanced stage.

A brand-new glazing, surprisingly, could have a large number of microscopic defects in the glass surfaces. These defects occur during the production and handling of the flat float glass and during the subsequent processes used to cut, bend, and laminate the flat glass to turn it into an automotive glazing. To the naked eye, the glass may appear to be near perfect as the defects that may be present as so small as to not be visible. But, at the microscopic level, the surface appears rough and can be seen to be dotted with flaws.

When the glass is placed in tension, these surface defects tend to open and expand, eventually leading to failure. Even when not in tension, the surface defects react with the moisture in the environment and slowly “grow” over time. This is known as slow crack growth. Glass exposed to the weather will age and weaken over time. If water is allowed to pool and sit for an extended period, the water will become highly alkaline from the sodium ions in the glass resulting in corrosion of the glass surface.

As discussed, the microscopic defects already present on the glass surface, will only continue to grow with time. Impact by small stones and other objects will also impart small defects. This increases with the miles driven. Snow, ice, rain, hail, and the action of the wipers dragging across the glass can also produce microscopic defects in the glass surface over the long term. If the vehicle has a human driver, they may not notice the degradation in the optical quality of the glazing. A driver or passenger will most likely start to notice the light scattering and haze that can result from these defects once they have progressed to more of a macro scale.

The camera systems that are being deployed on vehicles capable of full and partial autonomous operation need to have a clear field of view. Automatic rain sensing wipers and temperature activated defrosting circuits keep the camera field of view clear of rain, snow, and ice. But there is no effective way to detect a buildup of debris in the camera field of view or surface defects. With a driver, the wipers can be activated as needed. Without a driver, we are dependent upon other means which do not exist or have not been adequately developed. It may be possible to develop an algorithm that can detect and distinguish between objects of interest and debris but to date the typical system response is to shut off and notify the operator.

Another system that has been disclosed that attempts to solve this problem works by injecting light into the edge of a glazing. A camera is used to detect light that has been refracted by defects in the glass surface as well as light that has been decoupled from the glass layer by water on the outside surface of the glass. The problem with this is that there is no good location in most vehicles to mount a camera that has a field of view sufficient to substantially capture the entire daylight opening of the glazing. In addition, the camera will also have to differentiate between the light being refracted from the glass surface and the background illumination coming from both inside the vehicle and from the exterior. This results in a poor signal to noise ration and poor sensitivity to small defects.

In another version, the camera of the previous system is replaced by an array of light detectors such as depicted in FIG. 1A. The intensity of light from each light emitter is read from the corresponding photodiode located on the opposite edge of the glazing and recorded. This system can detect the presence of contaminants on either major surface of the glazing. The system can monitor the entire daylight opening of the glazing. The light emitters and detectors are coupled in a one-to-one relationship with the light from each detector being measured by a corresponding detector. The processing unit looks for a decrease in the signal received. When the level drops below a threshold, a wash cycle is initiated. If the light level is not restored after several attempts, it is assumed by default to be a permanent defect.

The main drawback of this system is its lack of sensitivity to the type and location of contaminants detected and to the long-term damage from abrasion and small impacts. It is primarily intended as a rain sensor and washer control. Water decouples the internally reflected light resulting in a very high signal to noise ratio which is easily detected.

Another issue with this type of method is that defects that refract the internally reflected light are harder to detect. While water and other contaminants on the glass surface will decouple the internally reflected light and reduce the intensity of the light detected, permanent defects introduced in the glass surface tend to refract most of the internally reflected light. In this process these defects redirect most of the light inside of the glass layer where it continues to be reflected rather than directing the light out of the glass layer.

Thus, the light intensity may be decreased at some detectors while it may increase at others by the same amount resulting in a negligible overall light intensity variation and making it harder if not impossible to detect permanent damage. Minor damage to the surface will likely be in the noise range and undetected. Another drawback of the disclosed system is the complicated mechanism used to flash the light emitters. A motorized wheel is used to chop the light, or a shutter system is needed.

It would be desirable to have a means to automatically detect, locate and quantify defects in general and changes in the condition of the glazing installed in a vehicle over time.

### BRIEF SUMMARY OF THE DISCLOSURE

The present invention utilizes the optical phenomenon known as Frustrated Total Internal Reflection (FTIR) and that of refraction to detect the condition of the glazing.

Light is injected into the edge of glass by a light emitter, at an angle greater than or equal to the critical angle for the glass/air interface (the critical angle by itself may change between 42 and 43.2 degrees depending on the type of the soda lime glass). At this angle of total internal reflection occurs inside of the glazing. A detector measures the intensity of light emitted from the edge. If frustrating elements are present such as water, snow ice, surface debris, the intensity of the light will decrease. If surface damage has occurred, the intensity will decrease at some detectors and increase at others due to refraction. By comparing a baseline measurement of the glazing to subsequent measurements, a processing unit, directly connected to the hardware or otherwise in communication with, can analyze and compare the measurements accurately detecting the presence of defects and debris and the safety status of the glazing with respect to the presence of glass damage and debris as well as their type, location, and severity.

### Advantages

Enables automated windshield washer operation.
Detection of defects while they can still be economically repaired.
Ensures a clear field of view for cameras.
Measures the location and severity of defects.
Estimate the type of defect and/or debris present.
Much greater sensitivity.

### BRIEF DESCRIPTION OF THE DRAWINGS

FIG. 1A shows a glazing with LED and detector arrays along short edges. All LEDs cycled on at once.

FIG. 1B shows a glazing with LED and detector arrays along short edges according to an embodiment of this invention. LEDs power one at a time with a one-to-one mapping: one LED to one Detector.

FIG. 2A shows a glazing with LED and detector arrays along short edges according to an embodiment of this invention. LEDs power one at a time with a one-to-many mapping: one LED to all Detectors.

FIG. 2B shows a glazing with LED and detector arrays along opposite short and long edges according to an embodiment of this invention. LEDs power one at a time with a one-to-one mapping: one LED to one Detector.

FIG. 3A shows a glazing with LED and detector arrays along opposite short and long edges according to an embodiment of this invention. LEDs power one at a time with a one-to-many mapping: one LED to all Detectors along opposite edge.

FIG. 3B shows Glazing with LED and detector arrays along opposite short and long edges according to an embodiment of this invention. LEDs power one at a time with a one-to-many mapping: one LED to all Detectors.

FIG. 4A is an example of the phenomenon FTIR when debris and a crack is present in a transparent substrate.

FIG. 4B is an example of the phenomenon FTIR when a crack is present in a transparent substrate.

FIG. 5 shows a laminated glazing with top and bottom edge arrays of detectors and LEDs according to an embodiment of this invention.

FIG. 6 shows a cross section of a typical laminated automotive glazing.

### REFERENCE NUMERALS OF DRAWINGS

2 Glass
4 Ray
6 Plastic bonding layer
8 Glazing
10 LED
15 Processing Unit
20 Detector
25 Coating
30 Crack
40 Debris
101 Surface one
102 Surface two
103 Surface three
104 Surface four
201 Outer glass layer
202 Inner glass layer

### DETAILED DESCRIPTION OF THE DISCLOSURE

The present disclosure can be understood more readily by reference to the detailed descriptions, drawings, examples, and claims in this disclosure. However, it is to be understood that this disclosure is not limited to the specific compositions, articles, devices, and methods disclosed unless otherwise specified, as such can, of course, vary.

It is also to be understood that the terminology used herein is for the purpose of describing aspects only and is not intended to be limiting.

The following terminology is used to describe the laminated glazing of the invention.

The term “glass” can be applied to many inorganic materials, include many that are not transparent. For this document we will only be referring to transparent glass. From a scientific standpoint, glass is defined as a state of matter comprising a non-crystalline amorphous solid that lacks the ordered molecular structure of true solids. Glasses have the mechanical rigidity of crystals with the random structure of liquids.

Glass is formed by mixing various substances together and then heating to a temperature where they melt and fully dissolve in each other, forming a miscible homogeneous fluid.

A glazing is an article comprised of at least one layer of a transparent material which serves to provide for the transmission of light and/or to provide for viewing of the side opposite the viewer and which is mounted in an opening in a building, vehicle, wall or roof or other framing member or enclosure.

Most of the worlds' flat glass is produced by the float glass process, first commercialized in the 1950s. In the float glass process, the raw ingredients are melted in a large refractory vessel and then the molten glass is extruded from the vessel onto a bath of molten tin where the glass floats.

The types of glass that may be used include but are not limited to the common soda-lime variety typical of automotive glazing as well as aluminosilicate, lithium aluminosilicate, borosilicate, glass ceramics, and the various other inorganic solid amorphous compositions which undergo a glass transition and are classified as glass included those that are not transparent. The glass layers may be comprised of heat absorbing glass compositions as well as infrared reflecting and other types of coatings.

Most of the glass used for containers and windows is soda-lime glass. Soda-lime glass is made from sodium carbonate (soda), lime (calcium carbonate), dolomite, silicon dioxide (silica), aluminum oxide (alumina), and small quantities of substances added to alter the color and other properties.

Laminates, in general, are articles comprised of multiple layers of thin, relative to their length and width, material, with each thin layer having two oppositely disposed major faces, typically of relatively uniform thickness, which are permanently bonded to one and other across at least one major face of each layer. The layers of a laminate may alternately be described as sheets or plies. In addition, the glass layers may also be referred to as panes.

Laminated safety glass is made by bonding two layers of annealed glass together using a plastic bonding layer 6 comprised of a thin sheet of transparent thermoplastic.

The plastic bonding layer 6 (interlayer) has the primary function of bonding the major faces of adjacent layers to each other. The material selected is typically a clear thermoset plastic. For automotive use, the most used bonding layer (interlayer) is polyvinyl butyral (PVB). Automotive grade PVB has an index of refraction that is matched to soda-lime glass so as to minimize secondary images caused by reflections at the PVB/Glass interface inside of the laminate.

Annealed glass is glass that has been slowly cooled from the bending temperature down through the glass transition range. This process relieves any stress left in the glass from the bending process. Annealed glass breaks into large shards with sharp edges. When laminated glass breaks, the shards of broken glass are held together, much like the pieces of a jigsaw puzzle, by the plastic bonding layer 6 helping to maintain the structural integrity of the glass. A vehicle with a broken windshield can still be operated. The plastic bonding layer 6 also helps to prevent penetration by objects striking the laminate from the exterior and in the event of a crash occupant retention is improved.

While the focus of the embodiments and discussion is laminated windshields, it can be appreciated that the invention is not limited to laminated windshields. The invention may be implemented with monolithic glazing as well as any of the other glazing positions in a vehicle.

For the sake of clarity and consistency the word debris shall be used to refer to any type of substance typically found deposited upon the exterior surface of an automotive glazing during normal operation including but not limited to dirt, grim, grease, leaves, tree sap, insects, bird feces, pollen, water, snow, ice, and haze.

The word defect shall be used to denote any type of permanent damage to the surface of the glass extending through the surface and penetrating to some even microscopic depth.

This includes but is not limited to what we would call cracks, scratches, and chips.

Surface damage describes the presence of defects on the surface of the glass.

Likewise, it should be noted that other means of illumination may be used in place of the LED light emitters of the described embodiments and this disclosure without departing from the concept of the invention. Any means that can provide the intensity and packaging requirements may be utilized including, laser light-emitting diodes, OLEDs, electro luminescent, fiber optics, light pipes and even means not yet invented. Further, any possible combination may be used. We shall refer to these as light emitters.

The types of light emitted by the light emitters of the invention include but are not limited to collimated or uncollimated, white, monochromatic, multi-wavelength light or any possible combination.

Controlled by the processing unit, the light emitters inject light into at least a portion of an edge of the glazing. Due to total internal reflection, no edge injected light exits from the major surfaces of the glazing so that even if visible light is used, it will not be noticeable to the occupants or from outside of the vehicle unless of course, there is a crack in the glazing which will refract some of the light out from the glass layer and be illuminated. This illumination of a crack or any other permanent defect upon the use of visible light injected by the light emitters is advantageous since it brings to evidence the presence of these defects otherwise easily ignored. The visual detection can be used in combination with a system detection and alert to indicate to the driver/user that it is time to repair the glazing.

However, when a defect is not present a great portion of the light injected by the light emitters will reflect and stay inside the glazing. Only a small portion of the injected light will be lost by absorption as it passes through the layers of the laminate. These losses will be constant and should be accounted for during baseline mapping.

Also, due to the properties of light, light from sources located inside of the vehicle and out will not have an effect of the detectors due to the incidence angle of the light. The light will pass through, be absorbed, or reflected by the glazing and not have any effect upon the detectors.

We shall use the word inject to describe the process of introducing light into the edge of the glazing wherein the glazing acts as a waveguide for the light. The light emitters must generally direct the light normal to the edge. The light emitters may be separated from the edge of the glazing by an air gap. Alternatively, they may be optically coupled to the edge. The light emitters may be integrated as a part of a molding, encapsulation, or trim. The injected light is coupled into the windshield and propagates through the thickness of the glazing to the other portions of the edge due to the Total Internal Reflection (TIR). The light exits the edge of the glazing where the intensity is measured by at least one detector also located along at least a portion of an edge. This is similar to the method used by some touchscreens.

In a laminate, the glass surface that is on the exterior of the vehicle is referred to as surface one 101 or the number one surface. The opposite face of the exterior glass layer 201 is surface two 102 or the number two surface. The glass 2 surface that is on the interior of the vehicle is referred to as surface four 104 or the number four surface. The opposite face of the interior layer of glass 202 is surface three 103 or the number three surface. Surfaces two 102 and three 103 are bonded together by the plastic layer 6. The reaming surfaces are the edges. This may appear obvious, but it is important to note that the light emitters and detectors must be located or coupled such that they emit and detect light along the edges, not merely close to the edges. Otherwise, the light will pass through the thickness of the glass and total internal reflection of the light will not occur. The assembly containing the detectors and emitters may be mounted in whatever manner is convenient. The angle of the injected light must be greater than the critical angle. This critical angle is the smallest angle of incidence at which total internal reflection occurs. The critical angle is a function of the index of refraction of the two medias that the light passes through. For soda-lime glass and air the critical angle is between 42 and 43.2 degrees. Coatings 25 may be applied in any surface of the laminated glazing which is going to act as a mirror to reflect the light inside the glass layer, serving as a helper to create total reflection of light regardless of the incident angle of the injection of light.

The invention applies to any automotive windshield, regardless of its additional functionality, e.g., solar-control. Many modern windshields, however, are equipped with such a solar-control coating, usually based on a very thin silver layer or layers embedded in a stack of thin dielectrics and deposited on surface two 102 of a laminated windshield.

Different embodiments of windshields include but are not limited to the application of coatings with two, three, or four silver layers.

Transparent coatings comprise very thin layers of silver. Normally, when silver is applied to a glass substrate, it creates a mirror. By depositing alternating layers of silver and dielectric compositions, the silver can be made transparent to visible light. However, there are limits as to how thick the silver layers can be made. Visible light transmission through a windshield must be at least 70% to meet regulatory requirements. We can deposit more silver by dividing the silver into multiple silver layers. A coating with two silver layers will have visible light transmission that is higher than a coating with one silver layer that is as thick as the two layers combined. The same applies to coatings with three and four layers of silver.

In most applications, solar-control coatings are substantially transparent in the visible wavelength range (380-780 nm) but is highly reflective in the near-IR range (>780 nm) of the solar spectrum (300-2500 nm).

In a preferred embodiment, coatings can be deposited on surface two 102 with a silver-inclusive coating deposited on it, reflecting the IR light generated by the emitters of the current invention.

In such embodiment, the injection angles are limited by the critical angle of the glass/air interface (surface one 101) and not by surface two 102 (in case of using a silver-inclusive coating).

While the invention can be implemented with a single light emitter and a single detector, the resolution and sensitivity will be minimal. In practice, an array of several light emitters and detectors is required to be practical. With sufficient numbers of light emitters and detectors, the sensitivity can be increased to where even small defects and quantities of debris can be detected. Further, with this approach, it is possible to also determine the approximate location of the defect or debris by using algorithms that can pinpoint the source of the change with the accuracy depending on the combination of light emitters and detectors used. In the same manner the severity and type can be estimated.

The light injection mode is sequential with the light emitters powered one by one in series. Due to the rapid rise time and light intensity of LEDs, the time that each LED is in the on state can be very short. Mechanical means, such as a shutter mechanism are not required as the rise time of LEDs is more than fast enough to allow cycling through the entire array in a short amount of time.

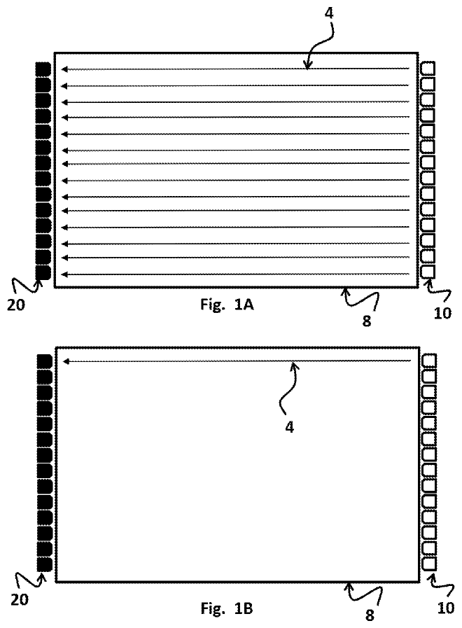

Substantially more sensitivity and information are obtained if the glass is scanned by sequentially switching the light emitters on and off, one by one or in groups. In this way, it is possible to know from which LED the light that reaches each detector came. This mode is shown in FIG. 1B.

The sequential switching of the light emitters may power multiple emitters that may be grouped and switched at the same time provided that the emitters are spatially separated along the edge by a sufficient distance such that they will not interfere with each other.

As an example, if we have sixteen light emitters along the same edge, we may be able to power them in the sequence, (1,9), (2,10) . . . (8,16).

Various sequences may be used, switching one by one and in groups.

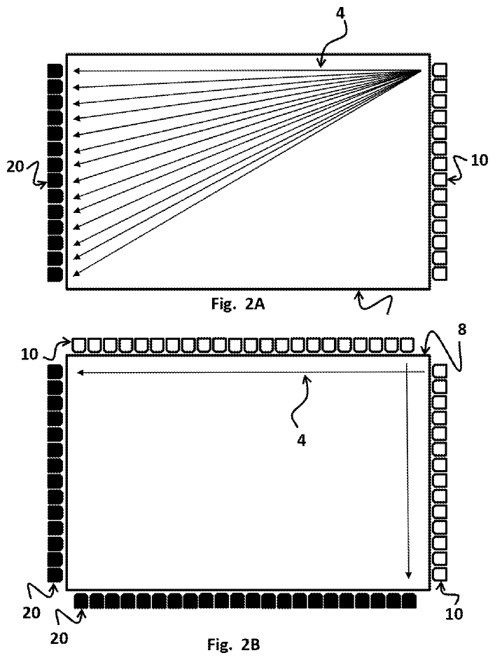

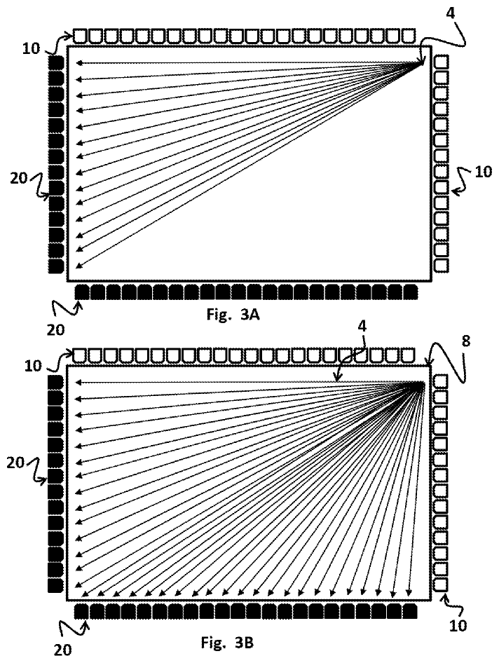

A combination of a one-to-one emitter detector mapping may be used such as in FIGS. 1A, 1B and 2B in addition to a one-to-many mapping of the data such as represented in FIGS. 2A, 3A and 3B.

As each light emitter injects light, multiple detectors are read in a one-to-many mapping of each light emitter to many light detectors.

A scan is the sequence of powering all of the light emitters and recording the intensity of the detectors.

While we only require having a single LED and detector along a single edge, placing the LEDs and detectors on opposite edges is preferred. Likewise, spacing the LEDs and detectors out along the entire length of an edge will also improve the results.

Further improvement can be made by placing LEDs along more than one edge, preferably adjacent edges which are substantially orthogonal. Likewise, detectors can also be placed along more than one edge as shown in FIGS. 2B, 3A and 3B.

When LEDs are powered individually, we can map each LED to a single corresponding detector or group of detectors or to many detectors. FIGS. 2A, 3A and 3B show this one-to-many mapping. By measuring the intensity of a single LED or group of LEDs at multiple detectors we can improve the sensitivity and accuracy of the hardware. In FIG. 3A, each LED is measured by all the detectors along the corresponding opposite edge. In FIG. 3B, all of the detectors along both the long and short edge measure each LED.

The signals from the detectors are read and stored in a processing unit programmed to execute detection, location, and classification algorithms.

When the glazing is first placed into service, an initial scan of the clean and undamaged surface of a windshield is mapped by the processing unit to create a baseline map of the surface. Subsequent scan maps are compared to the baseline and to each other.

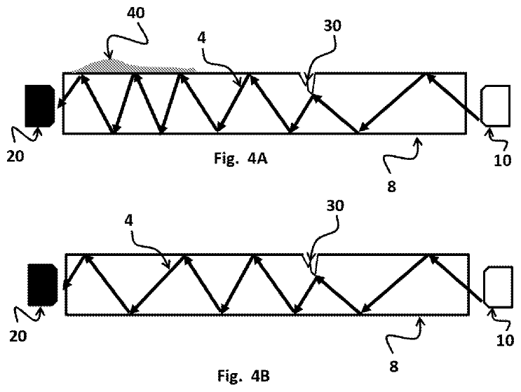

The baseline will shift given the presence of water, snow, ice, or debris such as accumulated on the major glass surfaces. These are known as “frustrating elements”. FIG. 4B shows the path of light through the thickness of the glazing and how it is disrupted by the presence of a frustrating element on the surface of the glass. The higher index of refraction of the frustrating element allows the internally reflected light to be decoupled from the glass layer and to exit the glass layer. This will lower the intensity of the light measured by the detectors.

These types of frustrating elements will tend to be temporary, removable by rain, the wipers, washers or by other cleaning means.

In FIG. 4A, the effect of a surface defect is shown. Damage to either of the major surfaces of the glazing will leave a permanent defect in the surface. By comparing the detected light intensity values to previous ones, it can be determined if the change is permanent or temporary and it can also be estimated the severity and location of the damage on the glazing. We note that any of the typical defect caused by impact or residual stress will be normal to the major surfaces and will reflect the injected light. However, no matter how the total internally reflected light hits an internal defect (surface chips and cracks), a substantial portion of it will still be redirected internally. This will primarily redistribute the registered light intensity between the sensors. The only chance of escaping is if it hits the internal defect at an angle less than the critical angle for the glass/air interface (between 42 and 43.2 degrees for most types of soda-lime glass) according to Snell's law. And the portion of such events compared to the total number of incidence angles is small.

Characterization of the cause of the changes in the scan data can be accomplished by empirical means. Various types of artificial intelligence methods such as fuzzy logic, classifiers and neural nets have also been used to identify various conditions.

At the same time, virtually all the light interacting with external ‘frustraters’ (grime, dirt, etc.) is known from touch-panel applications to be coupled out, thus reducing the total reading of the sensors.

If we look at a defect that is not in the direct path between a set of emitters and detectors, we can see that there will not be a change in the signal along the line-of-sight detector but rather at the ones that the defect casts a shadow upon so to speak. By measuring all of the detectors as each emitter is triggered, one by one, we can interpolate and get much higher resolution than would be possible with just a one-to-one sampling. These large, convoluted data sets can be analyzed to determine if the change is from debris, rain, abrasion, a stone chip, a crack, etc. by the characteristic signature that each type of defect will produce. We can also detect combinations of various types of defects.

Surface damage caused by abrasion will tend to produce microscopic faults or cracks that are perpendicular to the surface of glass. The light traveling inside of the glass layer will tend to be perpendicular to the defect and thus reflected by the defect. This also diverts the light, decreasing the intensity at some detectors while increasing it as others. This characteristic signature can be immediately detected for faults that are within the sensitivity threshold of the system. The system sensitivity is a function of the laminate dimensions, the number of light emitters and detectors, the light emitter and detector spacing, intensity and resolution, analog to digital convertor word size and other factors.

The presence of frustrating elements on the glazing creates a temporary and sometimes rapidly changing mapping pattern. Based on this convoluted mapping, the severity of the windshield debris is analyzed and reported. Optionally, the processing unit may issue a suggestion to clean the glazing or trigger the windshield washing mechanism. The temporary pattern is recorded by the algorithm in a memory for a certain period. After the windshield washing (or rain, etc.), a new pattern is compared to the previous patterns stored in the memory and ignored if they reveal no repeatable features. Multiple scan cycles may be needed until the condition of the windshield is defined as satisfactory and cleaning is no longer required. This occurs when little or no change is observed from scan to scan. If repeatable and/or unchanged features are revealed, the patterns are scrutinized, and the features may be interpreted as permanent frustrating elements (chips, cracks, etc.). The number of permanent frustrating elements may grow with time.

The size of individual permanent frustrating features, their total area, their proximity to each other in certain places, and other characteristics are analyzed and quantified by the processing unit and reported to the vehicle operator (driver or AI). The algorithm can also optionally notify the operator to take an action, e.g., to visually evaluate the windshield, repair it by filling with a polymer or, in an extreme case, offer a warning suggesting replacing it.

### EMBODIMENTS

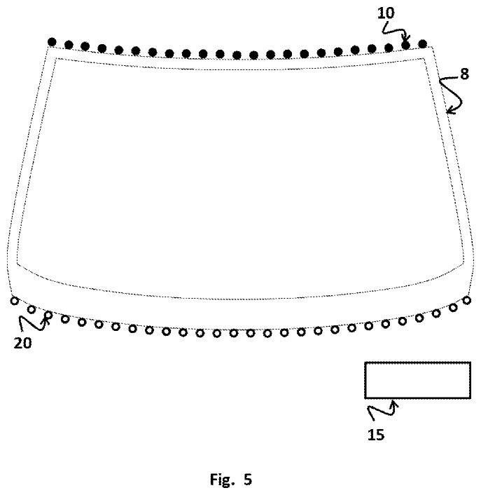

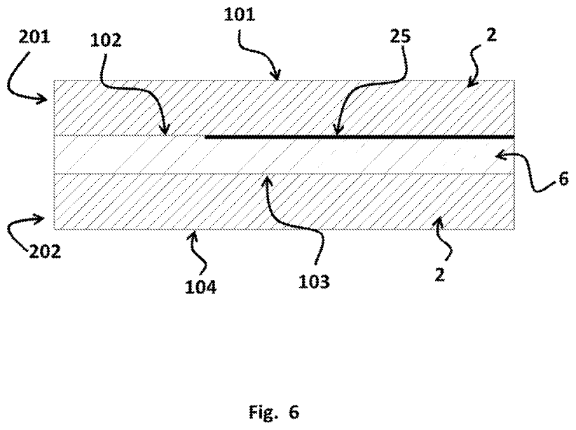

1.) Embodiment 1 comprised a laminated windshield as depicted in FIG. 5. An array of thirty-two LEDs 10 and thirty-two detectors 20 is installed along the two long edges of the windshield. The LEDs 10 are each powered for 10 ms each for a total scan duration of 320 ms. The detectors 20 measure the intensity of the light and store it as an 8-bit number. For each of the thirty-two LEDs 10, we have thirty-two detector values stored. The map of a single scan is comprised of 32 sets of 32 single byte values for a total of 32²=1024 bytes. Processing of the maps is facilitated by means of a fast Fourier transform (FFT). When the glazing is initially installed in the vehicle or replaced, a maintenance password is used to trigger an initial state scan by the processing unit which is stored and becomes the baseline for subsequent scans. During vehicle operation, the windshield is scanned every 15 seconds. If a change is found that is likely to be contamination on the outside surface of the windshield, the processing until 15 will send a message notifying the driver or the AI operating the vehicle to operate the wipers and washer when convenient. The processing unit 15 will continue to scan. When the wiper/washer operation has been detected by the processing unit 15, the scan will be checked for a return to baseline. If not, then the processing unit 15 will notify the vehicle operator of the possibility of permanent damage.
2.) Embodiment 2 takes the windshield of embodiment one and adds a second set of eight detectors 20 and LEDs 10 along the two shorter adjacent edges of the glazing. The scanning is conducted in the same manner as in embodiment one. The size of the output is increased to (32+8)²=1,600 bytes. Sensitivity and resolution are further increased. The processing unit 15, with the additional data, is better able to detect smaller changes and to more accurately estimate the location of the frustrater. This is useful as the entire surface of the windshield is not in the path of the wiper. If the processing unit detects a change in an area not in the wiper path, then the nature of the frustrater will take longer to be resolved. We would expect a contaminate to dimmish with rain, wind, and possible exposure to washer fluid even if not in the path of the wiper. It may be necessary to have the windshield hand cleaned or inspected.
3.) Embodiment three is shown in FIG. 5. The windshield is provided with an array of LEDs 10 along the top edge of glass. An array of detectors 20 is couple to the bottom edge of glass. The LEDs and the detectors are connected to a processing unit 15 which controls the LEDs, records the data from the detectors and analyzes the data. The processing unit may share functions related to the windshield as suits the application and available hardware. The processing unit function may be implemented as a standalone device or integrated with the navigation, HVAC, or other system.
4.) Embodiment four based upon embodiment one, but additionally comprising an outer glass layer 201 of 2.33 mm thick soda-lime glass, inner glass layer 202 of soda-lime glass. A PVB interlayer with a thickness of 0.76 mm used to laminate the two glass layers together and a coating 25 applied to surface two 102 in order to facilitate the total internal reflection of light in the laminate.

What is claimed is:

1. An automotive glazing system, comprising:
at least one glass layer;
at least one light emitters injecting light into at least a portion of at least one edge of the glazing;
a plurality of light detectors measuring simultaneously the intensity of light emitted by each of said plurality of light emitters from at least a portion of at least one edge of the glazing; and
at least one processing unit communicably coupled to the automotive glazing, the plurality of light emitters and the plurality of light detectors to:
scan periodically the intensity of light received by said plurality of light detectors;
store the scanned data;
compare new scans with historical data;
estimate the presence of contaminants by a drop in intensity at some detectors without an increase at some detectors; and
estimate the safety status of the glazing by identifying permanent damage by an increase in intensity at some detectors.

2. The automotive glazing system of claim 1, wherein said automotive glazing system comprises a laminate glazing having at least one plastic bonding layer.

3. The automotive glazing system of claim 2, wherein the plastic bonding layer is substantially refractive index matched to the glass.

4. The automotive system glazing of any one of the preceding claims wherein said plurality of light emitters is comprised of at least two arrays of light emitters along two adjacent edges of the automotive glazing.

5. The automotive glazing system of any one of the preceding claims wherein said plurality of light detectors is comprised of two arrays of light detectors along two adjacent edges of the automotive glazing.

6. The automotive glazing system of any one of the preceding claims wherein said plurality of light emitters is selected from the group of: light-emitting diodes and laser light-emitting diodes.

7. The automotive glazing system of any one of the preceding claims wherein the light from said plurality of light emitters is emitted using a sequential scan mode.

8. The automotive glazing system of any one of the preceding claims wherein said plurality of light detectors is read and the light is measured in a sequential scan mode.

9. The automotive glazing system of any one of the preceding claims wherein said at least one processing unit is also configured to issue a suggestion to clean the automotive glazing.

10. The automotive glazing system of any one of the preceding claims wherein said at least one processing unit is also configured to issue a suggestion to repair the automotive glazing.

11. The automotive glazing system of any one of the preceding claims wherein said at least one processing unit is also configured to optionally trigger a washing mechanism.

12. The automotive glazing system of any one of the preceding claims wherein the light from said plurality of light emitters is white.

13. The automotive glazing system of any one of the preceding claims wherein said plurality of light emitters emits light in multiple wavelengths.

14. The automotive glazing system of any one of preceding claims wherein the glazing is a windshield.

15. The automotive glazing system of any one of claims 1 to 14 wherein at least one glass layer comprises at least one coating.

16. The automotive glazing system of claim 15 wherein the at least one coating is located on surface two.

17. The automotive glazing system of any one of claims 15 and 16 wherein the at least one coating comprises at least one silver layer.

18. A method for detecting permanent damage to the surface of an automotive glazing system comprising the following steps:
injecting light between the two major surfaces of the glazing from the plurality of light emitters located along at least one edge of the glazing;
measuring the intensity of the light being emitted from the edge by the plurality of light detectors located along at least one other edge of the glazing;
estimating the presence of contaminants by a drop in intensity at some detectors without an increase at some detectors; and
estimating the glazing safety status by means of said process unit by identifying permanent damage by an increase in intensity at some detectors.

19. The method of claim 18 further comprising the steps of collecting and analyzing by means of said process unit convoluted maps of temporary and permanent frustraters of the total internal reflection.

20. The method of any one of claims 18 and 19 wherein said automotive glazing system comprises a laminate glazing having at least one plastic bonding layer.

21. The method of any one of claims 18 to 20 wherein said plastic bonding layer is substantially refractive index matched to the glass.

22. The method of any one of claims 18 to 21 wherein said plurality of light emitters is comprised of at least two arrays of light emitters along two adjacent edges of the glazing.

23. The method of any one of claims 18 to 22 wherein said plurality of light detectors is comprised of at least two arrays of light detectors along two adjacent edges of the glazing.

24. The method of any one of claims 18 to 23 wherein said plurality of light emitters is selected from the group of: light-emitting diodes, laser light-emitting diodes.

25. The method of any one of claims 18 to 24 wherein the light from said plurality of light emitters is emitted using a sequential scan mode.

26. The method of any one of claims 18 to 25 wherein said plurality of light detectors reads and measures the light in a sequential scan mode.

27. The method of any one of claims 18 to 26 wherein said at least one processing unit issues a suggestion to clean the glazing.

28. The method of any one of claims 18 to 27 wherein said at least one processing unit issues a suggestion to repair the glazing.

29. The method of any one of claims 18 to 28 wherein said at least one processing unit optionally triggers a washing mechanism.

30. The method of any one of claims 18 to 29 wherein the light from said plurality of light emitters is white.
